(19) United States
(12) Patent Application Publication
(10) Pub. No.: US 2008/0157479 A1
(43) Pub. Date: Jul. 3, 2008

(54) Low and reverse pressure application hydrodynamic pressurizing seals

(76) Inventors: Thurai Manik Vasagar, Hatfield, PA (US); Alan D. McNickle, Sellersville, PA (US); Glenn M. Garrison, Perkiomenville, PA (US); Diane R. McNickle, Telford, PA (US)

Correspondence Address: CHARLES N. QUINN;FOX ROTHSCHILD LLP, 2000 MARKET STREET, 10TH FLOOR, PHILADELPHIA, PA, 19103, US

(21) Appl. No.: 11/821,578

(22) Filed: Jun. 21, 2007

Related U.S. Application Data
(60) Provisional application No. 60/815,782, filed on Jun. 21, 2006.

(51) Int. Cl. F16J 15/34

(52) U.S. Cl. 277/400

(57) ABSTRACT

An assembly for sealing a liquid region from a gas region across an annular surface of a rotating shaft in turbomachinery, having a plurality of annular sealing ring segments facing the rotating shaft, at least one sealing ring segment including a dead end annular groove formed in a radially inwardly facing bearing surface at a position closer to the liquid region than to the gas region when the segment is positioned proximate the shaft surface, the groove extending arcuately in the direction of shaft rotation, at least one diagonal groove formed in the segment bearing surface and extending from an edge of the segment proximate the gas region to a position of communication with the dead end annular groove that is downstream, from a mouth of the diagonal groove at the segment edge, with respect to rotary movement of the shaft along the segment bearing surface.

### CROSS REFERENCE TO RELATED PATENT APPLICATION

This patent application claims the benefit of the priority under 35 USC 119 of provisional U.S. patent application Ser. No. 60/815,782, filed 21 Jun. 2006 in the names of Thurai Manik Vasagar, Alan D. McNickle (now deceased), and Glenn Marke Garrison, and assigned to Stein Seal Company.

### BACKGROUND OF THE INVENTION

Circumferential shaft seals are widely used in shaft sealing applications to prevent liquids from leaking into the gas side. Usually gas-side pressure is maintained higher than liquid-side pressure.

At low gas pressure conditions, anywhere from 5 psi and below and including negative pressures, circumferential seals can weep, namely leak liquids from the liquid side into the gas side.

FIG. 1 shows liquid and gas sides of a prior art, standard circumferential seal assembly. FIG. 2 shows back face and bore views of a prior art standard circumferential seal ring segment.

Leakage of liquids into the gas side adversely affects performance of the equipment where the seal is used. In case of an aircraft engine, oil leakage across the seal into a hot air side may cause oil coking or an engine fire.

### DESCRIPTION OF THE PRIOR ART

U.S. Pat. Nos. 4,423,879; 5,145,189 and 6,143,843 are known and believed representative of the prior art relevant to the patentability of this invention.

### OBJECT(S) OF THE INVENTION

Standard circumferential seals tend to weep/leak liquids from the liquid side of the seal to the region on the gas side of the seal at low gas-side pressure conditions, namely anywhere from 5 psi and below, including at negative pressures. This invention seeks to provide hydrodynamic seals that prevent or at least minimize such liquid weepage/leakage at such pressure conditions.

Prevention of oil weepage/leakage into the hot air side of an aircraft engine prevents the possibility of an engine fire. If the same air side is connected to an aircraft cabin to maintain cabin pressure, the prevention of oil leakage into the air side eliminates risk of the odor of oil in the cabin, eliminates the worry of maintaining the oil level in the bearing sump, and eliminates environmental hazards.

At certain operating conditions, hydrodynamic seals according to the invention can lift the rotating shaft or runner so that the seal runs on a thin film of gas, as contrasted to running on the bore surface. Compared to a bore-rubbing circumferential seal, the hydrodynamic seals according to the invention, when running on a film of gas, generate less heat. Less heat generation means less cooling oil is needed. As the seal runs on a thin film of gas, there is no rubbing between the seal bore and the runner or the shaft because there is essentially no contact. Hence, there is no significant seal bore wear. This provides extended seal wear life compared to a standard circumferential seal contacting the runner.

### SUMMARY OF THE INVENTION

The inclined pumping groove seal in accordance with aspects of this invention has grooves with shallow depths positioned on the bore of a circumferential seal.

The high pressure generated by hydrodynamic seals in accordance with the invention reduces seal loading on rotating shafts. In the practice of this invention, generated high pressure is preferably directed into a dead ended circumferential groove or into the segment joints, to prevent the liquid from leaking into the gas side.

Hydrodynamic seals are designed to generate higher pressures than the pressure on the supplied gas side of the seal. During a low or reverse gas pressure condition, the hydrodynamic seals according to the invention generate adequate high pressures due to relative shaft rotation against the stationary seal ring bore. This increases gas pressure differential across the seal ring. Increasing the gas side pressure above the threshold of the liquid weepage/leakage pressure level, by such hydrodynamic pressurization, prevents the liquid from leaking into the gas side.

### BRIEF DESCRIPTION OF THE DRAWINGS

FIG. 1 is a partially broken elevation taken in section, with section lines omitted for drawing clarity, of liquid and gas sides of a prior art circumferential seal assembly.

FIG. 2 is an elevation of an axially facing surface and a view of a radially inwardly facing surface of a prior art circumferential seal ring segment forming a part of the assembly shown in FIG. 1.

FIG. 3 is a partially broken elevation taken in section, with section lines omitted for drawing clarity, of liquid and gas sides of a circumferential seal assembly additionally showing the inboard view of one segment of the sealing ring, with an inclined pumping groove, in accordance with the invention.

FIG. 4 is an elevation of an axially facing surface and a view of a radially inwardly facing surface of a circumferential seal ring segment including inclined pumping grooves in accordance with the invention.

FIG. 5 is a view similar to FIG. 4 but with the direction of the pumping grooves reversed in accordance with the direction of shaft rotation in order to facilitate pumping provided by the grooves.

FIG. 6 illustrates two adjacent circumferential seal segments having inclined pumping grooves in accordance with the invention with a high pressure gas release hole being provided from the dead end arcuate groove of one of the segments through a socket face into the joint between the adjacent segments.

FIG. 7 is similar to FIG. 6 but illustrates a gas release slot, in place of the gas release hole, whereby high pressure gas may be released from the circumferential groove through the socket face into tongue and groove the joint between two adjacent circumferential seal segments having inclined pumping grooves.

FIG. 8 illustrates a number of variations of inclined pumping grooves in accordance with the invention, with each variation being shown on a single circumferential seal segment.

FIG. 9 illustrates a shallow pocket hydrodynamic seal ring segment showing at the tope of the figure a view of the segment taken in the axial direction and at the lower portion of the figure a view of the segment taken looking at a radially outwardly direction, showing the pockets located in the radially inwardly facing surface of the seal segment.

FIG. 10 illustrates various forms of pockets useful in a shallow pocket seal of the type illustrated in FIG. 9. Specifically, FIG. 10A illustrates a constant depth pocket; FIG. 10B illustrates a pocket with a taper having higher depth at the inlet end and lower depth at the outlet end; FIG. 10C illustrates a pocket having a very small dam between the end of the pocket and the outlet groove; FIG. 10D illustrates a pocket with a bleed slot to release generated high pressure directly into the outlet groove; FIG. 10E illustrates angular orientation of the inlet and outlet grooves for the pocket to improve gas flow into the shallow pocket and release generated high pressure gas from the pocket into the dead end annular groove of the circumferential seal segment.

FIG. 11 is a view, looking radially outwardly, of the radially inwardly facing surface of a circumferential seal segment having a single annular hydrodynamic groove connected to a socket bleed hole, all in accordance with the invention.

FIG. 12 is a view similar to FIG. 11 where the circumferential seal segment has two annular hydrodynamic grooves, one annular hydrodynamic groove being connected to a socket bleed hole and a second annular hydrodynamic groove being connected to the circumferential bore groove.

FIG. 13A is a view similar to FIGS. 11 and 12 where the circumferential seal segment has three annular hydrodynamic grooves connected to the circumferential bore groove and has an optional socket bleed hole.

FIG. 13B is a view similar to FIGS. 11, 12 and 13A of a circumferential seal segment where the segment shown in FIG. 13B has two sets of three annular hydrodynamic grooves connected to the circumferential bore groove with an optional socket bleed hole.

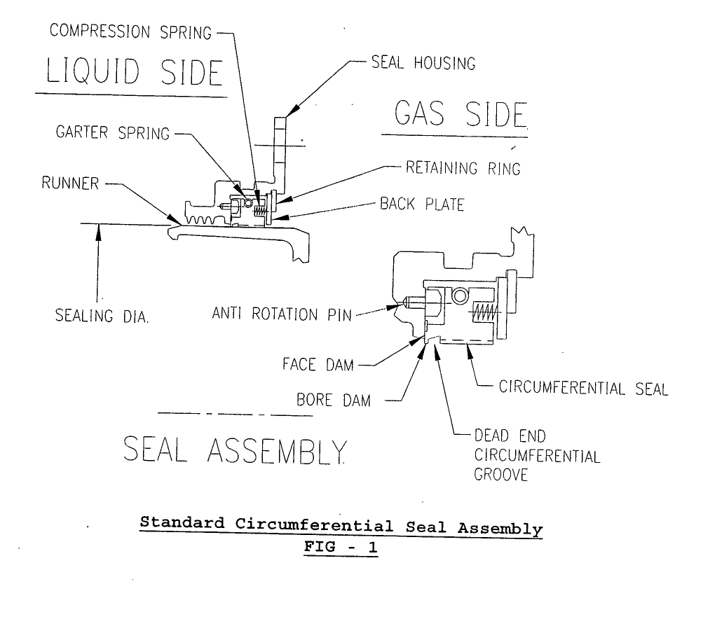

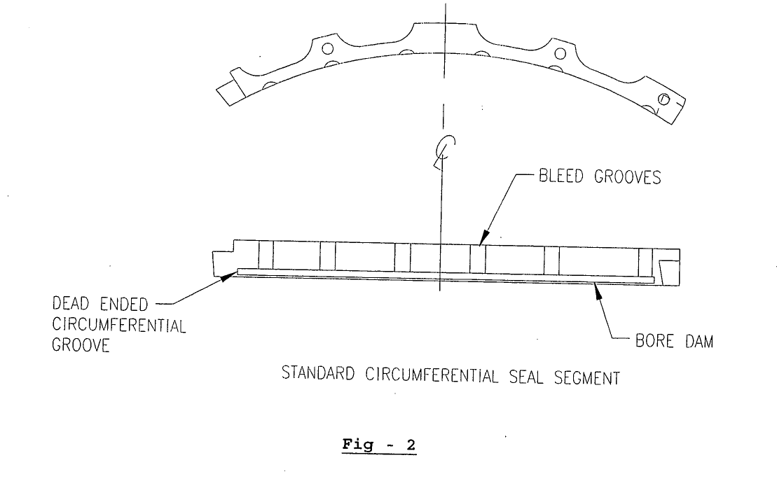

### DESCRIPTION OF THE INVENTION

There are several hydrodynamic seal-ring approaches disclosed in this patent application. These seals generate high gas pressures across seal rings and prevent fluids from leaking into the gas side.

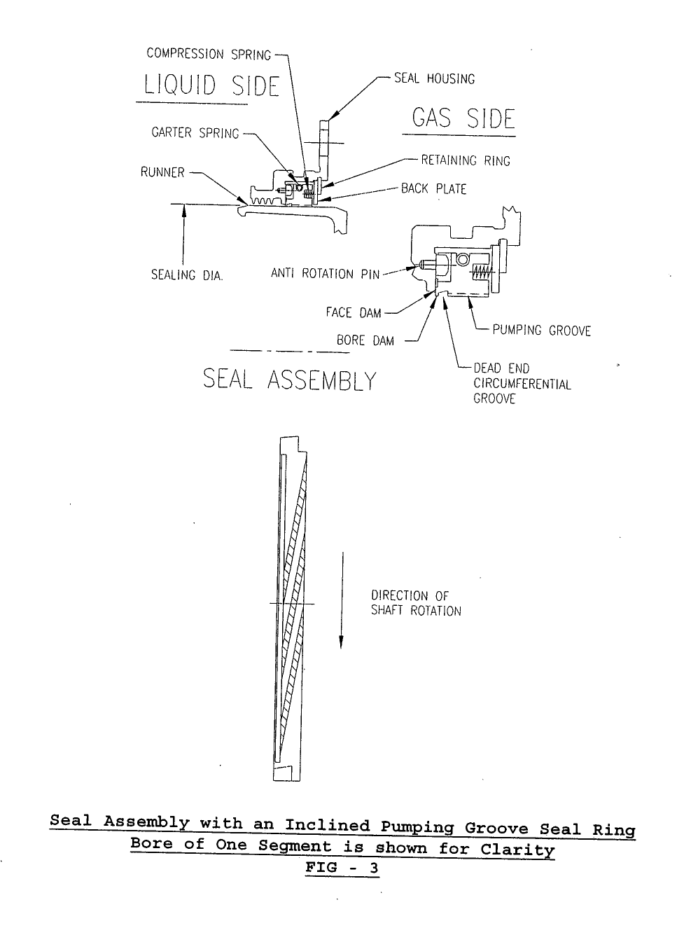

Hydrodynamic pumping groove seals at least greatly reduce and desirably prevent weepage or leakage of liquids into the region on the gas side of the seal, at low air side to oil side pressures, as well as when negative pressure exists on the air side. FIG. 3 shows a seal assembly in accordance with the invention with an inclined pumping groove seal.

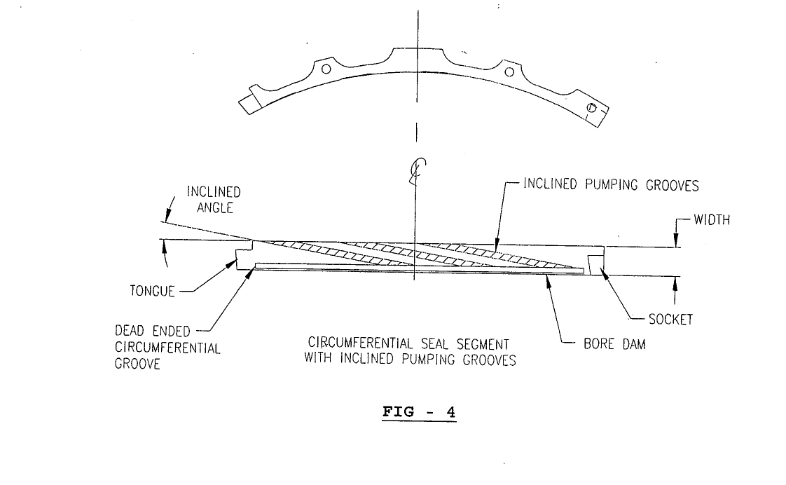

The inclined pumping groove seal includes several shallow inclined grooves on the bore of otherwise standard circumferential segments. These inclined grooves connect to a dead end circumferential groove. FIG. 4 shows the bore configuration of an inclined pumping groove seal ring segment in accordance with the invention. When the shaft rotates, the inclined grooves pump air along the grooves and generate high pressures in the dead end groove. This pressure is higher than the gas side pressure of the seal.

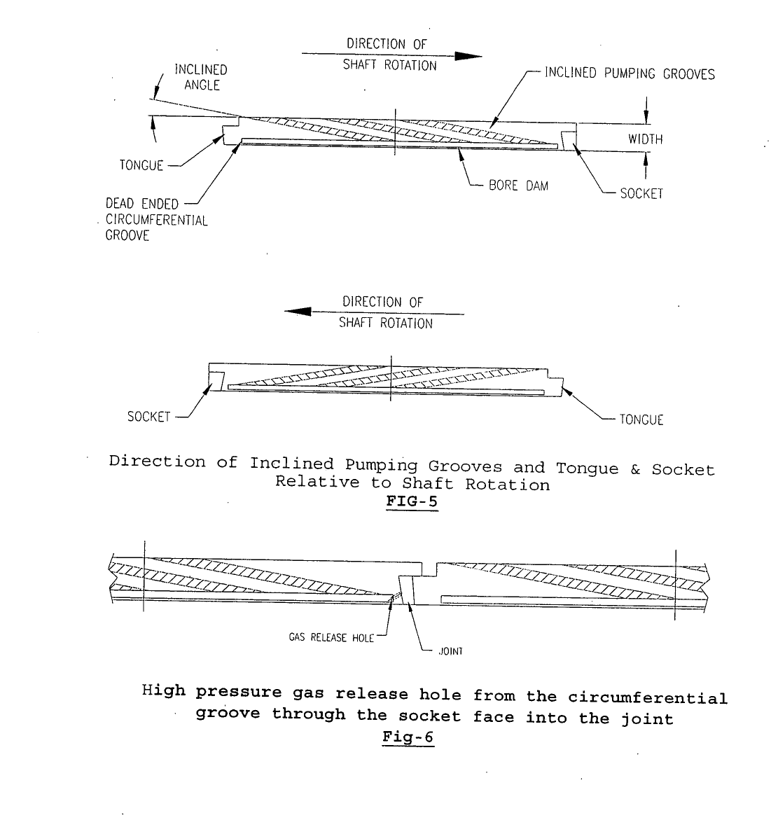

Generated pressure increases with increasing shaft speed. Since performance of the inclined pumping groove seal is shaft rotation direction dependent, the directional orientation of the inclined pumping grooves is as shown on FIG. 5. Correct orientation of the inclined pumping grooves relative to the direction of shaft rotation insures that high pressure is generated in the dead-ended circumferential groove.

When orienting the inclined pumping groove direction, based on the direction of shaft rotation, in a position reverse from what might otherwise be considered the standard orientation, the locations of the tongue and sockets of the segments also reversed in accordance with the invention, as shown in FIG. 5. At low gas pressures and low shaft rotational speeds, if the seal leaks liquid across the segment joints, high pressure gas from the dead end circumferential groove could be released into the joints by addition of holes or slots from the circumferential groove through the socket face into the joint. Releasing high-pressure gas into the joint forces liquid away and prevents the liquid from leaking into the gas side.

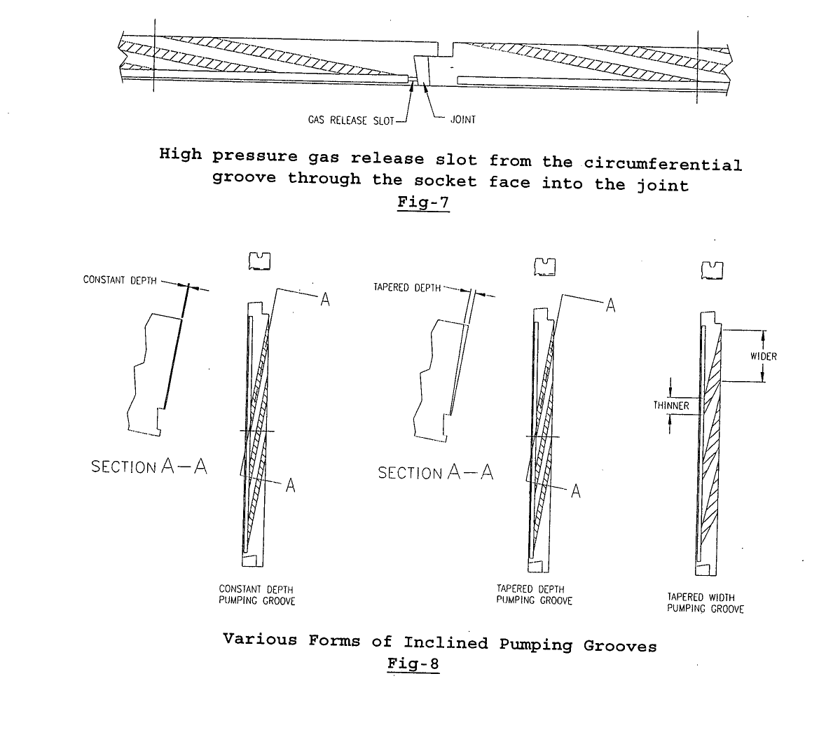

FIG. 6 shows a high-pressure gas release hole from a circumferential groove through the socket face into the joint, in accordance with the invention.

FIG. 7 shows a high-pressure gas release slot from a circumferential groove through the socket face into the joint, in accordance with the invention.

The inclined pumping groove seal generates high pressures across the seal bore and the segment joints to prevent liquid from leaking into the gas side, i.e., the inclined pumping groove seal brings the gas side pressure above the threshold liquid weepage/leakage pressure levels.

At certain speed and pressure conditions, the inclined pumping groove seal develops lift force. This force, if sufficient, allows the seal to run on a film of gas, by having a minute clearance between the carbon bore and either the rotating runner or the shaft. The high-pressure gas generated by the pumping action of the inclined pumping grooves passes through this minute clearance at sufficient velocity to push the liquid back and keep the liquid from entering the gas side.

FIG. 8 shows various forms of inclined pumping grooves, in accordance with the invention. These pumping grooves can have either sharp corners or cross sections with radii. There are three inclined pumping grooves shown on each segment bore. Depending on the application, the number of grooves, groove depth, and groove width can be adjusted. Each segment can even have grooves with various depths (multidepth grooves), instead of the same depths. The advantage of having segments with multidepth grooves is that in the event the very shallow groove(s) wears to the point of being ineffective due to rubbing wear, the other grooves will pump the gas and generate high pressures until they wear down and even wear off, one at a time.

The structure of hydrodynamic shallow pocket seals in accordance with the invention is much the same as the hydrodynamic inclined pumping groove seal mentioned in above, but the bore configuration is different.

A seal ring with hydrodynamic pockets generates high pressure. The generated high gas pressure is released in the dead end circumferential groove and, if required, into the segment joints by adding holes or slots from the dead end circumferential groove into the joints. The holes and the slots are same as the ones shown in FIG. 6 and in FIG. 7 respectively.

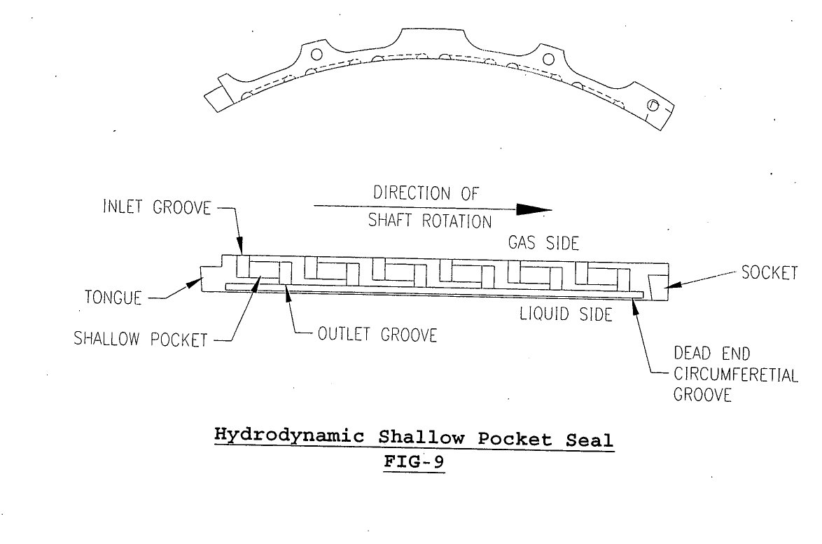

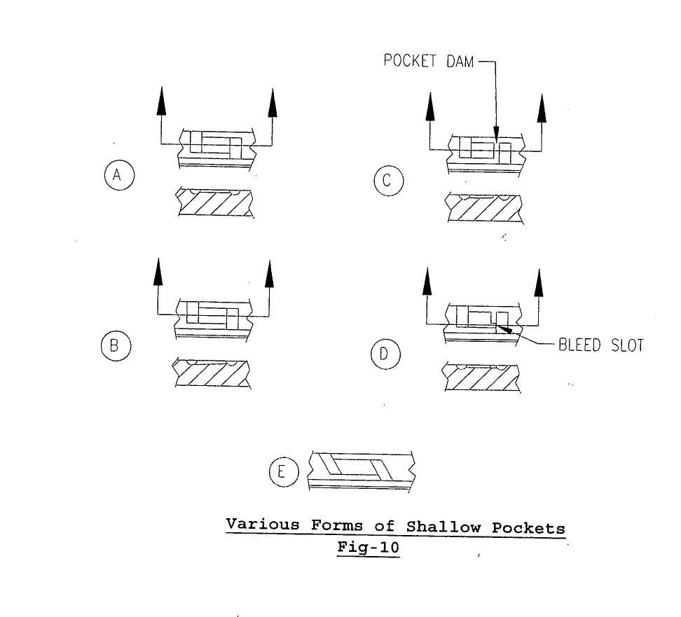

FIG. 9 shows a back face and bore view of a shallow pocket hydrodynamic seal ring segment, in accordance with the invention. Gas is supplied through the inlet groove of the pocket. The supplied pressure is then forced through the shallow pocket by rotation of the shaft. Forcing the gas through the shallow pocket generates higher pressure than the supplied pressure. This generated high pressure is fed into the dead end circumferential groove through the outlet groove.

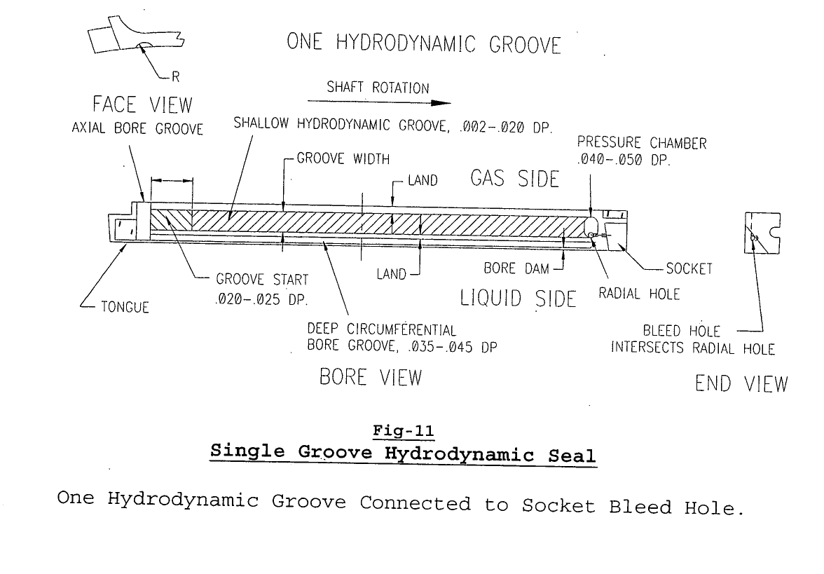

FIG. 10 shows various forms of shallow pockets, all in accordance with the invention. The number of pockets, the depth, the width, and the length can be changed, as needed, based on the application.

FIG. 10A shows a constant depth pocket.

FIG. 10B shows a pocket with a taper, with a higher depth at the inlet end and a lower depth at the outlet end.

FIG. 10C shows a pocket with a very small dam between the end of the pocket and the outlet groove. This arrangement generates very high pressure. The generated pressure is forced over the thin pocket dam into the outlet groove that in turn supplies high pressure into the dead ended circumferential groove.

A bleed slot can be added through the thin pocket dam to release the generated high pressure directly into the outlet groove, as shown in FIG. 10D.

Depending on the application, the inlet and the outlet grooves can be angled toward the direction of shaft rotation, as shown in FIG. 10E. The angled inlet and outlet grooves improve gas flow into the shallow pocket and the release of generated high-pressure gas into the dead end circumferential groove.

Depending on the application, each segment may even have pockets with various depths (multidepth pockets), instead of all pockets being the same depth. The advantage of having segments with multidepth pockets is that in the event the very shallow pocket wears down or even off due to rubbing wear, the other pockets will pump the gas and generate high pressures until they wear down or even wear off, one at a time.

FIGS. 11, 12, and 13 show additional circumferential seal bore geometries with hydrodynamic grooves, all in accordance with the invention.

The hydrodynamic grooves generate gas pressure in the bore of the seal to reduce or prevent liquid weepage into the gas side of the seal chamber at low or reverse pressure conditions.

Circumferential seals are used on gas turbine engines to seal the oil used to lubricate the bearings on the main shaft. The seals prevent oil from entering the hot air chambers of the engine and retain the bearing oil for lubrication.

FIG. 11 shows a single hydrodynamic groove connected to a socket bleed hole. This aspect of the invention combines a hydrodynamic groove with a bleed hole to blow high pressure gas into the socket at low pressure conditions, keeping liquid out of the tongue and socket joints. Blowing gas into the joints of the circumferential seal forces the liquid out of the joints, abating liquid weepage.

In prior practice, a bleed slot was added on the seal face of the socket, allowing high pressure gas to enter the joint under normal conditions when the gas side of the seal was at higher pressure than the liquid side. This approach has limitations. When the pressure differential across the seal drops to zero, or worse yet reverses, liquid enters the joints and leaks through the bleed slots into the gas side.

With providing a bleed hole connected to a hydrodynamic groove, gas pressure continues to blow into the joints even at low or reverse pressure conditions, preventing liquid weepage. The hydrodynamic grooves generate pressure in the seal bore with shaft rotation.

FIG. 11 shows the bore geometry of a single carbon graphite circumferential seal segment. In the drawing, the gas side is on the top and the liquid side is on the bottom. Shaft rotation is from left to right. The seal segment is installed on the outer diameter of a hard coated runner. A garter spring wraps around the outer diameter of the seal, holding the seal in contact with the runner. Each seal segment has a lock slot on its face, engaging an anti-rotation pin in the seal housing to prevent rotation.

Gas enters the hydrodynamic groove on the left side of the segment through the deep axial bore groove. With shaft rotation, the shallow hydrodynamic groove generates gas pressure, increasing from left to right, due to the viscosity of the gas and shear forces on the molecules. Pressurized gas is contained in the pressure chamber and is vented into the socket through intersecting radial and circumferential holes.

The axial bore groove intersects the circumferential bore groove. The circumferential bore groove does not receive gas pressure from a hydrodynamic groove.

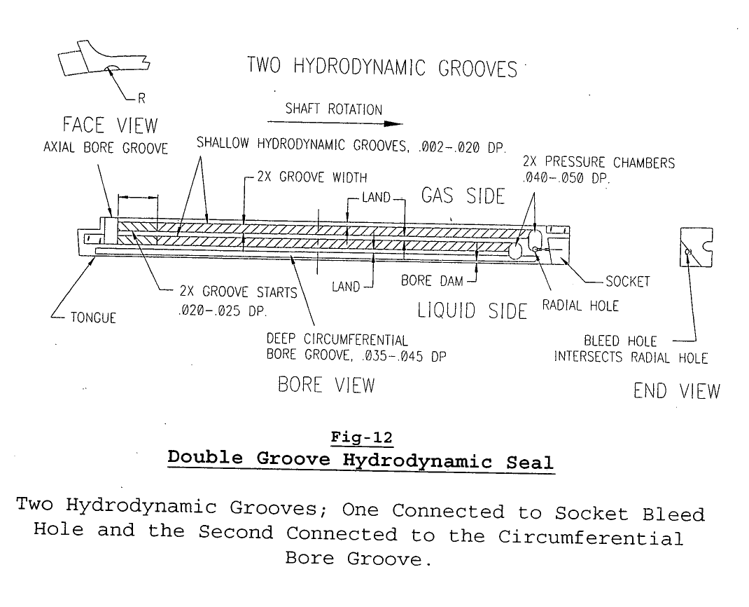

FIG. 12 illustrates an aspect of the invention in which the axial bore groove does not intersect the circumferential bore groove; pressure that is generated in the hydrodynamic groove is retained in the circumferential bore groove. There are two hydrodynamic grooves and two pressure chambers; they are not connected. The first hydrodynamic groove is vented into the socket by the bleed hole. The second hydrodynamic groove intersects the deep circumferential bore groove. Gas leakage across the bore dam prevents liquid weepage from entering the gas side of the seal at low or reverse pressure.

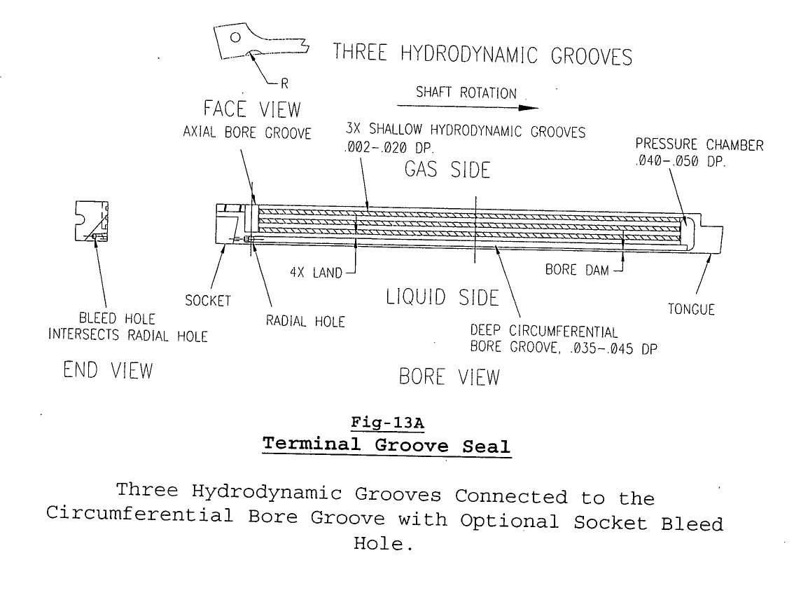

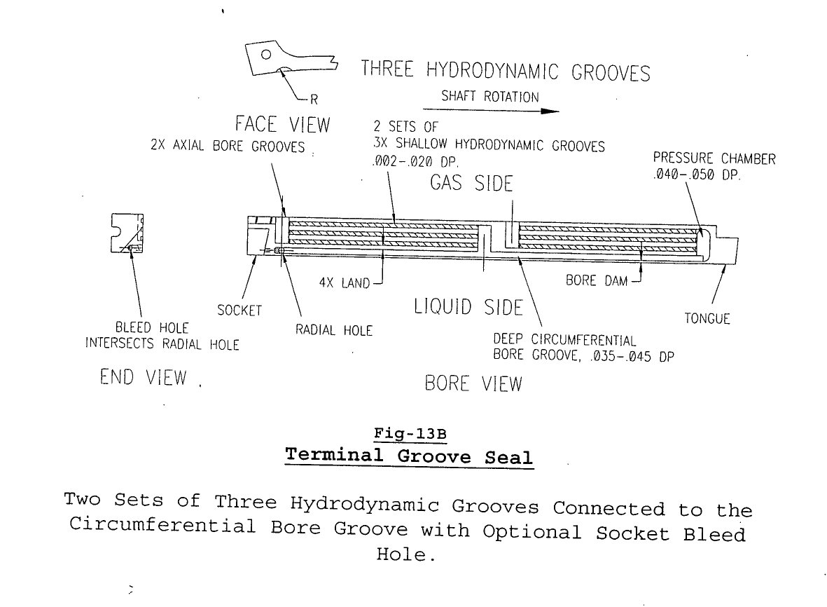

FIGS. 13A and 13B illustrate two versions of a terminal groove seal, namely full length grooves and two sets of half length grooves, manifesting aspects of the invention.

The axial bore groove does not intersect the circumferential bore groove. Gas pressure generated in the three narrow hydrodynamic grooves enters the deep circumferential bore groove. Again, gas leakage across the bore dam prevents liquid weepage from entering the gas side of the seal at low or reverse pressure.

The socket is at the left side of the segment in this design instead of on the right. An optional bleed hole is shown, at the end of the circumferential bore groove, to abate liquid weepage from the joints.

The following is claimed:

1. In an assembly for sealing a liquid region from a gas region across an annular surface of a rotating shaft in turbomachinery, having a plurality of annular sealing ring segments facing the rotating shaft, at least one sealing ring segment including a dead end annular groove formed in a radially inwardly facing bearing surface at a position closer to the liquid region than to the gas region when the segment is positioned proximate the shaft surface, the groove extending arcuately in the direction of shaft rotation, the improvement comprising at least one diagonal groove formed in the segment bearing surface and extending from an edge of the segment proximate the gas region to a position of communication with the dead end annular groove that is downstream, from a mouth of the diagonal groove at the segment edge, with respect to rotary movement of the shaft along the segment bearing surface.

2. The assembly of claim 1 in which the diagonal groove has constant width.

3. The assembly of claim 1 wherein the diagonal groove has constant depth.

4. The assembly of claim 2 wherein the diagonal groove has constant depth.

5. The assembly of claim 1 where there are a plurality of diagonal grooves in a sealing ring segment.

6. The assembly of claim 1 wherein the diagonal groove depth is greater at the groove mouth than at the position of communication with the dead end groove.

7. The assembly of claim 1 wherein the diagonal groove is wider at the mouth than at the position of communication with the dead end groove.

8. In an assembly for sealing a liquid region from a gas region across an annular surface of a rotating shaft in turbomachinery, having a plurality of adjoining annularly sealing ring segments facing the rotating shaft, each sealing ring segment including a dead end annular groove formed in a radially inwardly facing bearing surface at a position closer to the liquid region than to the gas region when the segment is positioned proximate the shaft surface, the annular dead end groove extending arcuately in the direction of shaft rotation, each segment having a circumferentially extending tongue at one end and a corresponding circumferentially recessed opening as the remaining end of the segment so that adjacent segments join in a tongue and groove fit, the improvement comprising at least one diagonal groove formed in the bearing surface of each segment and extending from an edge of the segment proximate the gas region to a position of communication with the dead end annular groove that is downstream, from a mouth of the diagonal groove at the segment edge, with respect to rotary movement of the shaft along the segment bearing surface, and a passageway connecting the dead end of the annular groove that is downstream with respect to rotary movement of the shaft along the segment bearing surface with the exterior surface of the opening receiving the tongue of the adjacent segment.

9. The assembly of claim 8 where in the passageway connecting the dead end of the annular groove with the exterior surface of the opening receiving the tongue of the adjacent segment runs through the segment.

10. The assembly of claim 8 where in the passageway connecting the dead end of the annular groove with the exterior surface of the opening receiving the tongue of the adjacent segment runs along the surface of the segment.

11. The assembly of claim 8 in which at least some of the diagonal grooves have constant width.

12. The assembly of claim 8 wherein at least some of the diagonal grooves have constant depth.

13. The assembly of claim 12 wherein at least some of the diagonal grooves have constant depth and have constant width.

14. The assembly of claim 8 where there are a plurality of diagonal grooves in each sealing ring segment.

15. The assembly of claim 8 wherein the depth of at least some of the diagonal grooves is greater at the groove mouth than at the position of communication with the dead end groove.

16. The assembly of claim 8 wherein at least some of the diagonal grooves are wider at the mouth than at the position of communication with the dead end groove.

17. In an assembly for sealing a liquid region from a gas region across an annular surface of a rotating shaft in turbomachinery, having a plurality of adjoining annularly sealing ring segments facing the rotating shaft, each sealing ring segment including a dead end annular groove formed in a radially inwardly facing bearing surface at a position closer to the liquid region than to the gas region when the segment is positioned proximate the shaft surface, the annular dead end groove extending arcuately in the direction of shaft rotation, each segment having a circumferentially extending tongue at one end and a corresponding circumferentially recessed opening as the remaining end of the segment so that adjacent segments join in a tongue and groove fit, the improvement wherein at least one segment comprises:
a. a plurality of recessed pockets formed in the radially inwardly facing bearing surface, separated from the dead end groove;
b. an outlet groove from each pocket communicating with the dead end groove;
c. an inlet groove for each pocket commencing at the edge of the segment that is closer to the gas side and leading therefrom to the pocket for fluid flow from the gas side into the pocket as the shaft rotates;
d. the pocket inlet and outlet grooves communicating with the respective pocket at opposite annularly spaced extremities of the pocket;
e. the pocket inlet groove being upstream from the outlet groove with respect to the direction of shaft surface movement along the pocket as the shaft rotates.

18. The assembly of claim 17 wherein the pockets are of uniform depth.

19. The assembly of claim 17 wherein the pockets are of constant depth.

20. The assembly of claim 17 wherein the pockets are deeper proximate the inlet groove than at the outlet groove.

21. The assembly of claim 17 wherein the improvement further comprises a dam between at least one of the pockets and the outlet groove from that pocket.

22. The assembly of claim 21 wherein the improvement still further comprises a bleed slot in the dam for flow of fluid from the pocket into the dead end groove.

23. The assembly of claim 17 wherein the inlet and outlet grooves are inclined with mouths of the respective grooves being upstream of the groove outlets with respect to the direction of shaft surface movement passing the pocket.
